(19) United States
(12) Patent Application Publication
(10) Pub. No.: US 2006/0225250 A1
(43) Pub. Date: Oct. 12, 2006

(54) Hinge system for storm door

(76) Inventor: Noubar Yeremlan, Wayne, PA (US)

Correspondence Address: RATNERPRESTIA, P O BOX 980, VALLEY FORGE, PA, 19482-0980, US

(21) Appl. No.: 11/398,881

(22) Filed: Apr. 6, 2006

Related U.S. Application Data
(60) Provisional application No. 60/668,865, filed on Apr. 6, 2005.

(51) Int. Cl. E05D 5/06

(52) U.S. Cl. 16/389

(57) ABSTRACT

According to an exemplary embodiment of this invention a door assembly including a door frame and a hinge is provided. The door assembly comprises a hinge insert coupled to the door frame. The hinge insert includes a knuckle segment. A continuous hinge segment mounted to a doorway includes at least two knuckle segments spaced apart. The knuckle segment of the hinge insert is positioned between the at least two knuckle segments of the continuous hinge segment. At least one bushing is positioned between the knuckle segment of the hinge insert and one of the at least two knuckle segments of the continuous hinge segment. At least one bushing is positioned between the knuckle segment of the hinge insert and the other of the at least two knuckle segments of the continuous hinge segment.

### CROSS REFERENCE TO RELATED APPLICATIONS

This application claims the benefit of the filing date of the provisional application entitled “HINGE SYSTEM FOR STORM DOOR” filed Apr. 6, 2005 and assigned Ser. No. 60/668,865,the contents of which are incorporated herein by reference.

### BACKGROUND OF THE INVENTION

This invention relates to hinges which are used to mount a pivoting door to a doorway. The pivoting door may be any style of door, such as a storm door; a screen door or an aluminum door. There is a need to further develop and improve the door hinges used to mount the door to the doorway.

### SUMMARY OF THE INVENTION

According to an exemplary embodiment of this invention a door assembly including a door frame and a hinge is provided. The door assembly comprises a hinge insert coupled to the door frame. The hinge insert includes a knuckle segment. A continuous hinge segment mounted to a doorway includes at least two knuckle segments spaced apart. The knuckle segment of the hinge insert is positioned between the at least two knuckle segments of the continuous hinge segment. At least one bushing is positioned between the knuckle segment of the hinge insert and one of the at least two knuckle segments of the continuous hinge segment. At least one bushing is positioned between the knuckle segment of the hinge insert and the other of the at least two knuckle segments of the continuous hinge segment.

According to an exemplary embodiment of this invention a continuous hinge configured to hingedly couple a door to a doorway is provided. The continuous hinge comprises a hinge insert having a knuckle segment, wherein the hinge insert is configured to be mounted to a door. A continuous hinge segment configured to be mounted to a doorway has at least two knuckle segments spaced apart, wherein the knuckle segment of the hinge insert is positioned between the at least two knuckle segments of the continuous hinge segment. At least one bushing is positioned between the knuckle segment of the hinge insert and one of the at least two knuckle segments of the continuous hinge segment. At least one bushing is positioned between the knuckle segment of the hinge insert and other of the at least two knuckle segments of the continuous hinge segment.

### BRIEF DESCRIPTION OF THE DRAWINGS

FIG. 1 is a front elevation view of a door according to aspects of the invention;

FIG. 2 is a top plan view of a cross section of a door and hinge assembly according to aspects of the invention;

FIG. 3 is an exploded view of the door and hinge assembly of FIG. 2;

FIG. 4 is an exploded perspective view from the top left of the hinge assembly of FIG. 2; and

FIG. 5 is a detailed perspective view from the top left of the continuous hinge segment of FIG. 2.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Referring generally to the Figures, a door and hinge assembly comprises a door pivotably coupled to a doorway (not shown) by a hinge. The door generally includes four adjoining rail sections defining a door frame. The hinge comprises a plurality of hinge inserts mounted to a rail section, a continuous hinge segment mounted to the doorway, and a rod that interlocks the hinge inserts and the continuous hinge segment together, so that the door can pivot with respect to the doorway.

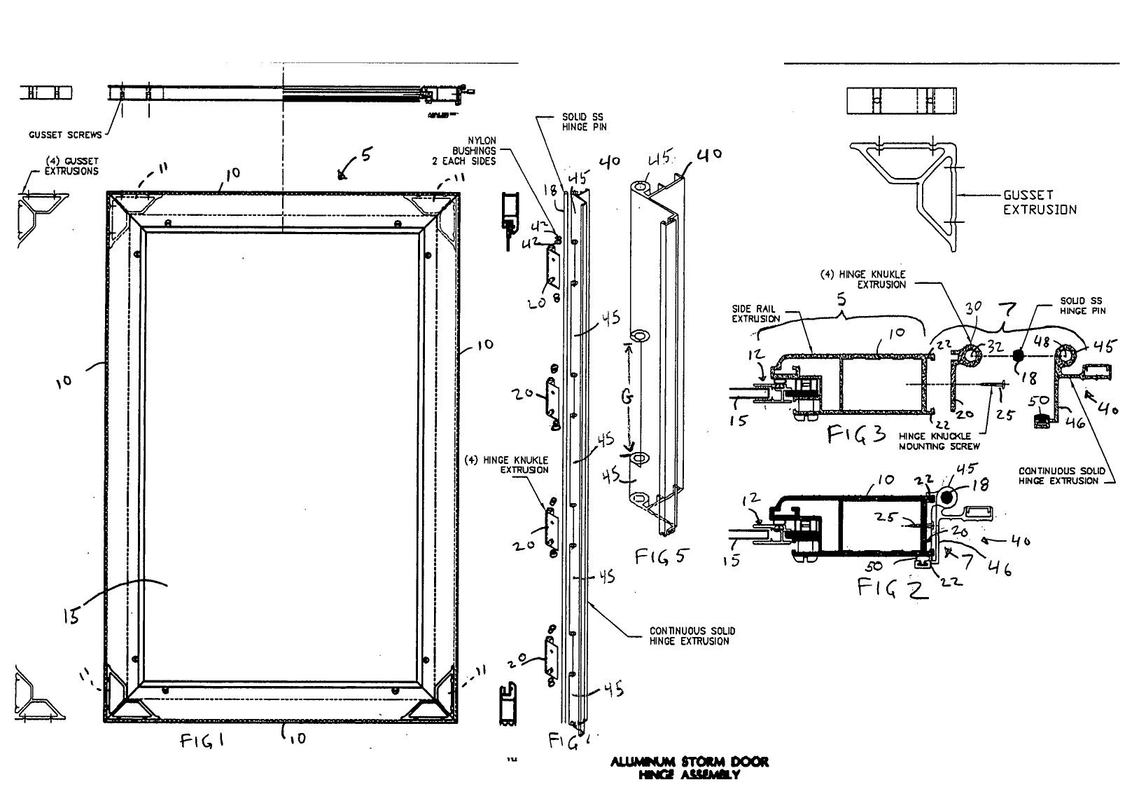

Referring now to FIG. 1, an exemplary embodiment of a door 5 is illustrated. The exemplary door 5 comprises four adjoining rail sections 10. The rail sections 10 are joined together by four gussets 11 that are fixedly mounted to the four interior corners of door 5. A glass panel 15 supported by a bracket 12 is fastened to the adjoining rail sections 10, as shown in FIGS. 2 and 3. The rail sections 10 are optionally fabricated by an extrusion process and formed from aluminum. According to this exemplary embodiment, the door 5 is a glass storm door, although, it should be understood that the door may be a screen door, panel door, or any other style of door.

A partial top plan view of an exemplary embodiment of an assembly comprising door 5 and a hinge 7 is illustrated in FIG. 2 (assembled view) and FIG. 3 (exploded view). The rail section 10 of door 5 is pivotably mounted to the hinge side of a doorway by hinge 7. The hinge 7 may be referred to as a piano hinge or a continuous hinge. The hinge 7 comprises a plurality of hinge inserts 20 mounted to rail section 10 (only one hinge insert shown in FIGS. 2 and 3), a continuous hinge segment 40 mounted to the doorway and a rod 18 that interlocks the hinge inserts 20 and the continuous hinge segment 40 together.

The hinge inserts 20 are captured within opposed flanges 22 of rail section 10. Each hinge insert 20 is also fixedly mounted to the hinge side of rail section 10 by one or more fasteners 25. The opposed flanges 22 and the fasteners 25 jointly support the weight of the door. The opposed flanges 22 provide greater strength and durability than fasteners 25 alone to couple hinge insert 20 to door 5. It is contemplated that, in the event of a fastener failure, the interface between the hinge inserts 20 and opposed flanges 22 could support the weight of the door. In this embodiment, four hinge inserts 20 are included, as best shown in FIG. 4, however any number of hinge inserts may be utilized depending upon the weight of the door and the strength of the hinge components.

A cylindrical knuckle segment 30 is formed along the entire length of one end of hinge insert 20. The knuckle segment 30 includes a centrally located clearance hole 32. The functionality of knuckle segment 30 is described in greater detail below with reference to the continuous hinge segment 40. The hinge inserts 20 are optionally fabricated by an extrusion process and formed from a hardened aluminum or steel material.

The continuous hinge segment 40 is fixedly coupled to the hinge side of a doorway corner (not shown). Specifically, the interior surfaces 46 of continuous hinge segment 40 are mounted to the surfaces of the doorway corner by a fastener (not shown) or any other fastening means. A series of integral cylindrical knuckle segments 45 are disposed along the length of continuous hinge segment 40, as best shown in FIGS. 4 and 5. Each knuckle segment 45 includes a centrally located clearance hole 48, having a diameter approximately equal to the diameter of the clearance hole 32 of knuckle segment 30.

Adjacent knuckle segments 45 are separated by a distance “G” that is slightly greater than the length of knuckle segment 30. In assembly, one knuckle segment 30 of a hinge insert 20 is positioned in each gap “G” between adjacent knuckle segments 45 in an alternating fashion, such that the axes of the clearance holes 32 and 48 are substantially aligned. The alternating arrangement of knuckle segments 30 and 45 optionally extends the entire height of door 5. The continuous hinge segment 40 may be fabricated by an extrusion process and formed from an aluminum or steel material.

Conventional hinges often include discrete knuckle portions fastened to the continuous hinge segment. It has been discovered that the discrete knuckle segments can separate from the continuous hinge segment under the weight of a door. In contrast with a conventional hinge, the knuckle segments 45 are integrated with continuous hinge segment 40. The integral design of continuous hinge segment 40 is better suited to support the weight of a door as compared with a conventional hinge.

Two bushings 42 are positioned at each planar interface between knuckle segment 45 and knuckle segment 30, as shown in FIG. 4. Each bushing 42 comprises a first outer diameter portion, a second outer diameter portion larger than the first portion, a shoulder defined between the outer diameter portions and a clearance hole disposed through the longitudinal axes of the first and second outer diameter portions. In assembly, the first outer diameter portion of bushing 42 is positioned within each clearance hole 32, 48 on the top and bottom surfaces of the respective knuckle segments. The annular bushings 42 may be formed from nylon, Teflon or any other suitable bushing material. The bushing could also take the form of a washer to achieve similar results. The shoulder thickness of the bushings 42 may be any dimension sufficient to rest in the gaps between the knuckle segments 30, 45.

The bushings 42 are positioned between adjacent knuckle segments to cushion the load bearing points and enhance the pivoting action of hinge insert 20. The bushings 20 absorb the impact, and reduce resistance caused by friction between the knuckle segments. Using two bushings 42 at each knuckle interface eliminates friction, because the opposing surfaces of the bushings 42 slide against one another as the door pivots. In the absence of bushings 42, the knuckle segments would tend to bind together under the weight of the door, thereby impairing the pivoting action of hinge insert 20.

The rod 18 pivotably connects continuous hinge segment 40 with hinge insert 20, such that door 5 may pivot with respect to the doorway. The rod 18 is positioned in the clearance holes 32 and 48 and carried within the clearance hole of the bushings 42. In this arrangement, contact between rod 18 and the surfaces of clearance holes 32 and 48 is substantially limited, thereby reducing metal-to-metal contact and subsequent wear. The rod 18 optionally spans the entire length of continuous hinge segment 40 and/or door 5. Although not shown, a wood dowel pin is mounted in a clearance hole 32, 48 of one or more knuckle segments at the bottom end of hinge 7. The dowel pin is a stop or blocking feature that retains rod 18 within hinge 7. Moreover, in use, an end-user may reduce the height of a door by severing a portion of the door along with a portion of the wood dowel pin, as opposed to severing the stainless steel rod 18 which may be difficult to cut.

In addition to the bushings and knuckle segments, rod 18 also supports the weight of door 5. It has been discovered that a single rod spanning a substantial portion of the length of the hinge is better suited to support the weight of the door, as compared to conventional hinges having multiple rods or a single rod extending only partially along the length of a hinge. The rod is optionally solid and formed from stainless steel or any other high-strength material.

For the purpose of clarity, the exemplary hinge 7 shown in the FIG. 4 comprises four hinge inserts 20 (thus, four knuckle segments 30), four fasteners 25, one continuous hinge segment 40 having five distinct knuckle segments 45, sixteen bushings 42 and a rod 18. Although, it should be understood that a hinge may include any number or arrangement of components.

A weather-strip 50 is mounted at the distal end of continuous hinge segment 40. The weather-strip 50 is positioned in compressive contact with door 5, when the door is in the closed position (as shown in FIG. 2), to limit the passage of air or liquid. The weather-strip 50 may be any commercially available gasket material.

While exemplary embodiments of the invention have been shown and described herein, it will be understood that such embodiments are provided by way of example only. Numerous variations, changes and substitutions will occur to those skilled in the art without departing from the spirit of the invention. For example, the door may be a household screen door, storm door or any other type of commercial or residential door. Moreover, the door and hinge components may be formed by any suitable manufacturing process using any appropriate material or materials known in the art.

Accordingly, it is intended that the appended claims cover all such variations as fall within the spirit and scope of the invention.

What is claimed:

1. A door assembly including a door frame and a hinge comprising:
a hinge insert coupled to the door frame and having a knuckle segment;
a continuous hinge segment mounted to a doorway and having at least two integral knuckle segments spaced apart from each other, said knuckle segment of the hinge insert being positioned between the at least integral two knuckle segments of the continuous hinge segment;
at least one bushing positioned between the knuckle segment of the hinge insert and one of the at least two integral knuckle segments of the continuous hinge segment; and
at least one bushing positioned between the knuckle segment of the hinge insert and the other of the at least two integral knuckle segments of the continuous hinge segment.

2. The door assembly of claim 1 further comprising two bushings positioned between the knuckle segment of the hinge insert and one of the at least two integral knuckle segments of the continuous hinge segment.

3. The door assembly of claim 1 further comprising two bushings positioned between the knuckle segment of the hinge insert and the other of the at least two integral knuckle segments of the continuous hinge segment.

4. The door assembly of claim 1 further comprising, a plurality of hinge inserts coupled to the door frame.

5. The door assembly of claim 1 further comprising opposed flange segments extending from the door frame, said hinge insert positioned between the opposed flange segments.

6. The door assembly of claim 1, wherein the bushings are formed from nylon.

7. The door assembly of claim 1 further comprising axially aligned clearance holes disposed in the knuckle segments.

8. The door assembly of claim 7, further comprising a rod positioned in the clearance holes, to interlock the knuckle segments of the hinge insert and continuous hinge segment together.

9. The door assembly of claim 8, wherein the rod substantially spans the length of the door and the continuous hinge.

10. A continuous hinge configured to hingedly couple a door to a doorway comprising:
a hinge insert having a knuckle segment and configured to be mounted to a door;
a continuous hinge segment configured to be mounted to a doorway having at least two integral knuckle segments spaced apart from each other, said knuckle segment of the hinge insert being positioned between the at least two integral knuckle segments of the continuous hinge segment;
at least one bushing positioned between the knuckle segment of the hinge insert and one of the at least two integral knuckle segments of the continuous hinge segment; and
at least one bushing positioned between the knuckle segment of the hinge insert and other of the at least two integral knuckle segments of the continuous hinge segment.

11. The continuous hinge of claim 10 further comprising two bushings positioned between the knuckle segment of the hinge insert and one of the at least two integral knuckle segments of the continuous hinge segment.

12. The continuous hinge of claim 10 further comprising two bushings positioned between the knuckle segment of the hinge insert and the other of the at least two integral knuckle segments of the continuous hinge segment.

13. The continuous hinge of claim 10 further comprising axially aligned clearance holes disposed in the knuckle segments.

14. The continuous hinge of claim 13, further comprising a rod positioned in the clearance holes, to interlock the knuckle segments of the hinge insert and continuous hinge segment together.

15. The continuous hinge of claim 14, wherein the rod spans the length of the continuous hinge.
